(19) United States
(12) Patent Application Publication
(10) Pub. No.: US 2018/0121502 A1
(43) Pub. Date: May 3, 2018

(54) User Search Query Processing

(71) Applicant: The Bureau of National Affairs, Inc., Arlington, VA (US)

(72) Inventor: Landon Prieur, Long Valley, NJ (US)

(73) Assignee: The Bureau of National Affairs, Inc., Arlington, VA (US)

(21) Appl. No.: 15/337,919

(22) Filed: Oct. 28, 2016

(51) Int. Cl. G06F 17/30; G06N 99/00

(52) U.S. Cl. CPC G06F 17/30448; G06F 17/30554; G06N 99/005; G06F 17/3053; G06F 17/30598

(57) ABSTRACT

Systems and methods for processing a search query are provided. A search query is received. In a first processing stage, initial results are generated for the search query. In a second processing stage, a topic associated with the search query is identified based on the initial results and additional results of the search query are determined. The additional results are associated with a topic that matches the topic associated with the search query. Search results are provided as including the initial results and the additional results.

### TECHNICAL FIELD

The present invention relates generally to user search query processing and more particularly to an improved search query processing engine for providing initial search results supplemented with additional search results.

### BACKGROUND OF THE INVENTION

Search engines are designed to identify relevant results from one or more databases based on a user's search query. However, at times, results of a user's search query may be limited, particularly with regards to esoteric subject matter.

As an example, legal research search engines are designed to return sources of primary authority (e.g., case law, statutes, or regulations) and sources of secondary authority (e.g., law review articles or treatises) based on a user's search query. These sources of secondary authority are typically generated by attorneys who provide analysis based on their review of primary sources and their experience. Because of the labor intensive nature of generating these sources of secondary authority, such sources of secondary authority often do not exist or are scarce for some areas of the law, such as, e.g., recently passed legislation.

### SUMMARY

In accordance with one or more embodiments, a two stage search query processing engine is provided for generating initial results in a first processing stage and additional results in a second processing stage. The search query processing engine thus supplements the initial results with the additional results. The additional results may relate to subject matter unlikely to be included in the initial results. For example, the additional results may be a document or sections of a document.

In accordance with one or more embodiments, systems and methods for processing a search query are provided. A search query may be received as a string having one or more keywords. In a first processing stage, initial results are generated for the search query based on the one or more keywords. In a second processing stage, a topic associated with the search query is identified based on the initial results and additional results of the search query are determined based on a topic associated with the additional information matching the topic associated with the search query. Search results are provided that include the initial results and the additional results.

In accordance with one or more embodiments, the additional results may be a document or a section extracted from a document. For example, the document may be a regulatory document, such as electronic data gather, analysis, and retrieval (EDGAR) content. Sections of the document are associated with topics in a preprocessing step using trained relevance ranking algorithm. Advantageously, the sections of the EDGAR content provided as additional results require no editorial input from a user.

In accordance with one or more embodiments, the topic associated with the search query is identified as the topic associated with one or more of the initial results. For example, the topic associated with the search query may be identified as topics associated with the top N results (e.g., top 5 or 10 results) of the initial results. The topics associated with each of the initial results may be determined in a preprocessing step using a trained relevance ranking algorithm.

These and other advantages of the invention will be apparent to those of ordinary skill in the art by reference to the following detailed description and the accompanying drawings.

### BRIEF DESCRIPTION OF THE DRAWINGS

FIG. 1 shows a high-level diagram of a communications system, in accordance with one embodiment;

FIG. 2 shows a system architecture of a search query processing system, in accordance with one embodiment;

FIG. 3 shows a flow diagram of a method for associating data sources of a first data set with one or more topics, in accordance with one embodiment;

FIG. 4 shows a flow diagram of a method for associating sections of additional data sources (e.g., regulatory filings) of a second data set with one or more topics, in accordance with one embodiment;

FIG. 5 shows a flow diagram of a method for processing a search query, in accordance with one embodiment; and

FIG. 6 shows a high-level block diagram of a computer for implementing a search query processing engine, in accordance with one embodiment.

### DETAILED DESCRIPTION

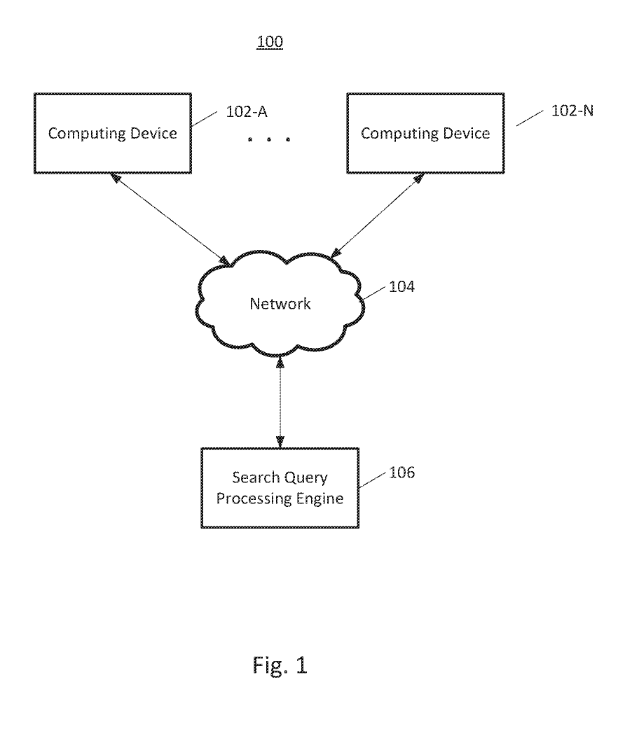

FIG. 1 shows a high-level diagram of a communications system 100, in accordance with one or more embodiments. Communications system 100 includes computing devices 102-A, . . . , 102-N (collectively referred to as computing devices 102). Computing devices 102 may comprise any type of computing device, such as, e.g., a computer, a tablet, or a mobile device. Computing devices 102 may communicate with each other (or other network entities) via network 104. Network 104 may include any type of network or combinations of different types of networks, and may be implemented in a wired and/or a wireless configuration. For example, network 104 may include one or more of the Internet, an intranet, a local area network (LAN), a wide area network (WAN), a Fibre Channel storage area network (SAN), a cellular communications network, etc.

End users of computing devices 102 may interact with a search query processing engine 106 via network 104. For example, end users may interact with search query processing engine 106 via an interface of a web browser executing on computing device 102, an application executing on computing device 102, an app executing on computing device 102, or any other suitable interface for interacting with search query processing engine 106. In one embodiment, end users of computing devices 102 may submit a search query to search query processing engine 106 via network 104 and in response search query processing engine 106 provides search results.

Conventionally, systems for processing search queries provide search results based on the search query. These search results may be limited depending on the subject matter of the search query. In such cases, it is beneficial to supplement existing search results with additional results.

Advantageously, embodiments of the present invention provide for a search query processing engine 106, which processes an end user's search query in two stages to generate search results comprising initial results supplemented with additional results. In a first processing stage, search query processing engine 106 provides initial results of the end user's search query. In a second processing stage, search query processing engine 106 identifies a topic of the end user's search query based on the initial results and identifies a document (e.g., regulatory filing) or section of a document that is associated with a topic that matches or most closely matches the topic of the end user's search query as additional results. Search query processing engine 106 in accordance with embodiments of the invention thus provides for improvements in computer related technology by providing for a two stage search query processing engine, which generates search results comprising initial results determined in a first processing stage supplemented with additional results determined in a second processing stage.

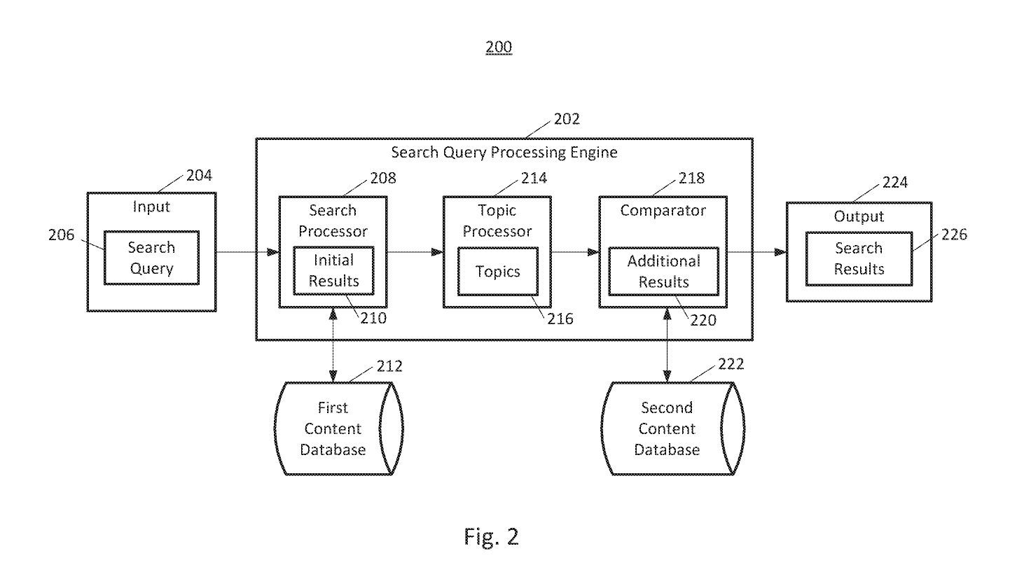

FIG. 2 illustratively depicts a system architecture 200 for processing a search query, in accordance with one or more embodiments. System architecture 200 includes search query processing engine 202. In one embodiment, search query processing engine 202 is search query processing engine 106 in FIG. 1.

While search query processing engine 202 will be discussed herein as a search query processing engine configured to query legal data sets in accordance with one embodiment, it should be understood that the present invention is not so limited. Search query processing engine 202 may be configured for processing search queries for any type of data.

Search query processing engine 202 receives input 204 comprising search query 206 defining a search criteria. Input 204 may be received from an end user of computing device 102 via network 104 in FIG. 1. In one embodiment, search query 206 includes a string comprising one or more keywords and search operators. The search query 206 may also comprise other indicators defining the search criteria, such as, e.g., codes (e.g., in hexadecimal format) defining a date range for the search query selected by the end user via a user interface. In other embodiments, search query 206 may alternatively or additionally include an image, an audio file, or data of any other suitable format. Search query processing engine 202 processes search query 206 to generate initial results 210 in a first processing stage and additional results 220 in a second processing stage to provide search results 226.

In a first processing stage, search processor 208 of search query processing engine 202 is configured to analyze search query 206 to identify initial results 210 from a first data set 212. First data set 212 comprises data sources stored on one or more databases. The data sources may include data of any type (e.g., statutes, regulations, court decisions, restatements of law, treatises, law review articles, etc.) and may be of any suitable format (e.g., portable document format, webpage, etc.).

In one embodiment, search processor 208 identifies initial results 210 from first data set 212 by comparing search query 206 with keywords associated with each of the data sources in first data set 212. The keywords associated with each of the data sources of first data set 212 may be determined by indexing the data sources in a prior preprocessing step (i.e., prior to receiving input 204). The indexing step associates the data sources with keywords relating to the content of the data sources. In one embodiment, the keywords associated with each of the data sources are numeric codes associated with a list of words corresponding to a taxonomy and/or a numeric identifier identifying other data sets that the data source is similar to corresponding to the results of a trained relevance ranking algorithm. Search processor 208 thus provides initial results 210 from first data set 212 ranked or ordered according to their relevance to search query 206. In one embodiment, search processor 208 provides initial results 210 for search query 206 using search processing techniques known in the art.

In one embodiment, the data sources of first data set 212 are categorized into, or otherwise associated with, content sets. For example, first data set 212 may include a statutes content set, a court decisions content set, or a content set of any other category. Each content set may be associated with a topic and associated keywords. The content set and corresponding topics and keywords may be defined by an end user. In one embodiment, an end user of computing device 102 may select a content set to be searched as part of input 204. Search processor 208 analyzes search query 206 according to the selected content set. For example, search processor 208 may limit its search processing to the selected content set such that initial results 210 are results identified from the selected content set.

In a second processing stage, topic processor 214 and comparator 218 of search query processing engine 202 are configured to identify additional results 220 from a second data set 222 based on initial results 210.

Topic processor 214 is configured to identify one or more topics 216 associated with initial results 210. For example, in one embodiment, topic processor 214 determines topics 216 as including the topics associated with the top N results of initial results 210, where N is any positive integer (e.g., top 5 or 10 results of initial results 210). In another embodiment, topic processor 214 determines topics 216 as including topics associated with a content set selected by an end user via input 204.

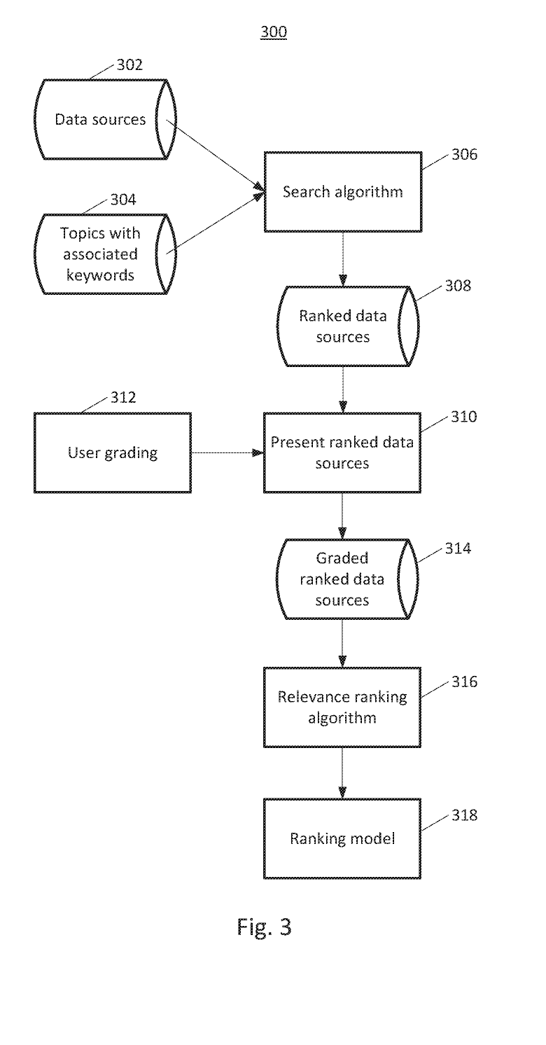

The topics may be associated with each data source in first data set 212 in a prior preprocessing step. The preprocessing step to identify topics associated with each data source in first data set 212 is further discussed below with respect to FIG. 3. The data sources of first data set 212 may additionally or alternatively be manually assigned topics by a user during the preprocessing step.

In one embodiment, first data set 212 stores associations between data sources and topics as determined in the preprocessing step discussed below with respect to FIG. 3. For example, each data source in first data set 212 may be tagged with one or more topics by associating each data source with metadata indicating the one or more topics. In another example, first data set 212 may comprise a table or any other suitable data structure indicating the association between each data source and its topics.

Topics 216 are used by comparator 218 to identify additional results 220 from second data set 222. Second data set 222 comprises one or more additional data sources (e.g., documents) stored on one or more databases. The additional data sources of second data set 222 may include any type of data in any suitable format. In one embodiment, additional data sources relate to subject matter that is not, or that is not likely to be, included in first data set 212 and returned as initial results 210. In another embodiment, additional data sources are documents, or sections extracted from documents, with little or no additional editorial input from a user. In another embodiment, additional data sources are documents produced editorially and intended to educate and/or to anticipate an end user's next area of research. In a further embodiment, additional data sources are the keywords identified by comparator 218 so that an end user of computing device 102 can directly trigger a new search query by selecting the desired keywords. In one embodiment, the additional data sources of second data set 222 are categorized into, or associated with, content sets and keywords, similar to first data set 212.

In one embodiment, the additional data sources of second data set 222 include documents filed with an organization (e.g., governmental organization), such as, e.g., regulatory filings. For purposes of this application, the term “regulatory filings” refers to documents submitted by companies or other entities to an organization that regulates its activities. An example of regulatory filings is EDGAR (electronic data gathering, analysis, and retrieval) content.

For purposes of this application, EDGAR content refers to data relating to a corporation or other entity submitted to the Securities and Exchange Commission (SEC). EDGAR content may include information on a variety of subject matters organized by section and labeled with title headings. For example, EDGAR content may include a section providing an overview of mobile telephone regulations. It is unlikely that this type of content would be included in first data set 212 and returned in initial results 210, as searching EDGAR content is a labor intensive process. Further, end users would likely curtail their research before exhausting all available sources of information. It would therefore be advantageous to end users searching for mobile telephone regulations to supplement initial results 210 with the section providing an overview of mobile telephone regulations from the EDGAR content as additional results 220. In accordance with an embodiment, the section of EDGAR content providing an overview of mobile telephone regulations is automatically extracted by topic processor 214 and provided as additional results 220 by comparator 218 with no editorial input from a user required.

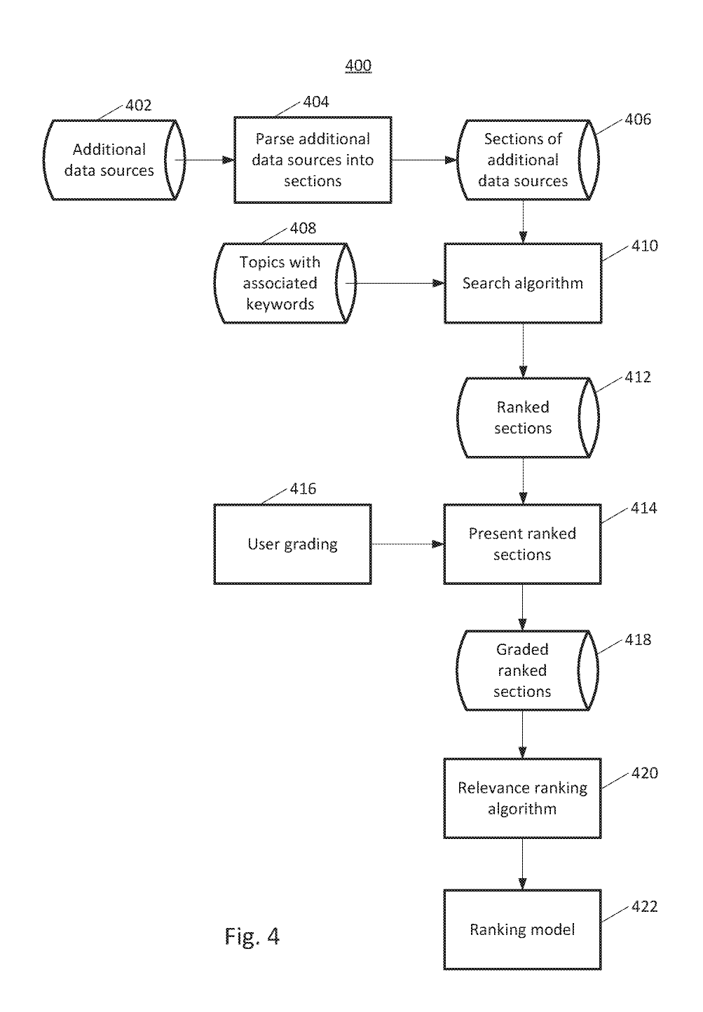

In one embodiment, the additional data sources of second data set 222 are parsed into sections and each section is associated with a topic. This may be performed in a prior preprocessing step. The preprocessing step to parse additional data sources into sections and identify topics associated with each section is further discussed below with respect to FIG. 4. The additional data sources of second data set 222 may additionally or alternatively be manually assigned topics by a user during the preprocessing step.

In one embodiment, second data set 222 stores associations between additional data sources, or sections of additional data sources, and topics as determined in the preprocessing step discussed below with respect to FIG. 4. For example, each of the additional data sources or sections of the additional data sources in second data set 222 may be tagged with one or more topics by associating each additional data source or section of additional data source with metadata indicating the one or more topics. In another example, second data set 212 may comprise a table (or any other suitable data structure) indicating the association between each additional data source or section of the additional data sources and its topics.

Comparator 218 is configured to compare topics 216 of initial results 210 with topics associated with sections of the additional data sources to provide additional results 220. For example, in one embodiment, where input 204 does not include a selected content set (i.e., the search was over all content sets), additional results 220 include additional data sources or sections of additional data sources associated with a topic that matches, or most closely matches, one or more of topics 216. In another embodiment, where input 204 includes a selected content set, the additional data sources associated with topics that correspond to topics 216 are further ranked based on the topics and keywords associated with the selected content set. The ranking may be performed using techniques known in the art. The ranked additional data sources are provided as additional results 220.

In one embodiment, second data set 222 stores associations between additional data sources, or sections of additional data sources, and topics according to a topic taxonomy. The topic taxonomy defines hierarchical relationships between topics. For example, the topic taxonomy may define the topic “environmental regulation” as a subset of “governmental regulation.”

In one example, topics 216 may be mapped to one or more corresponding topics in the topic taxonomy that match or most closely match, according to a predefined topic mapping. Additional data sources, or sections of additional data sources, associated with the one or more corresponding topics are provided as additional results 220. If there are no additional data sources, or sections of additional data sources, associated with the one or more corresponding topics, additional data sources, or sections of additional data sources, associated with the topics at a next lower hierarchical level are provided as additional results 220. The lowest hierarchical level comprises the keywords identified by comparator 218 so that an end user of computing device 102 can directly trigger a new search query by selecting the desired keywords.

Search query processing engine 202 thus provides output 224 comprising search results 226. Search results 226 include initial results 210 supplemented with additional results 220. Output 224 may be presented on a display device, such as, e.g., a display device associated computing device 102 of FIG. 1.

Advantageously, search query processing engine 202 provides additional data sources, or sections of additional data sources, of second data set 222 as additional results 220 for supplementing initial results 210. This is particularly advantageous as reviewing and analyzing the additional data sources is a labor intensive process and is therefore unlikely to be included in first data set 212 and not returned in initial results 210. Search query processing engine 202 therefore provides for an improvement in the computer related technology of search query processing by providing for a two stage search query processing engine, which generates search results comprising initial results determined in a first processing stage supplemented with additional results determined in a second processing stage.

FIG. 3 shows a flow diagram 300 for associating data sources with one or more topics, in accordance with one or more embodiments. Flow diagram 300 of FIG. 3 will be discussed with reference to system architecture 200 of FIG. 2. Flow diagram 300 may be performed as a preprocessing step. For example, flow diagram 300 may be performed before receiving search query 206 as input 204. Flow diagram 300 may be performed by topic processor 214 in FIG. 2.

Search algorithm 306 receives data sources 302 and topics with any associated keywords 304 as input. In one embodiment, data sources 302 are data sources of a particular content set stored in first data set 212. For example, data sources 302 may be data sources associated with a court opinions content set stored in first data set 212. The topics with associated keywords 304 may be defined by a user (e.g., a user other than the end user of computing device 102). For example, the Telecoms Regulation topic could be associated with a list of keywords including telephony, VoIP, and packet.

Search algorithm 306 identifies data sources that are most relevant to each of the topics. For example, in one embodiment, search algorithm 306 indexes data sources 302 to determine keywords associated with data sources 302, and compares the keywords associated with each topic with the keywords associated with data sources 302 to identify the data sources that are most relevant to each of the topics. This process is repeated for each individual topic and corresponding keywords. In one embodiment, search algorithm 306 identifies the data sources that are most relevant to each of the topics in turn according to methods known in the art. Search algorithm 306 provides ranked data sources 308, ranked from most relevant to least relevant to each topic.

Ranked data sources 308 are presented 310 to a user, e.g., using a display device. User grading 312 is received from the user to evaluate the relevance of the ranked data sources 308 to the topic, on a scale ranging from relevant to not relevant, to provide graded ranked data sources 314. In one embodiment, the top K ranked data sources 308 are graded with user grading 312, where K is any positive integer. The user grading 310 reflects weights that are applied on ranked data sources 308. For example, the weights may be based on keywords appearing in data sources 302, the similarity of a data source with another data source that is already assigned a topic, or any other factor. These weights are inherent in user grading 310.

Graded ranked data sources 314 are input into relevance ranking algorithm 316 as training data. Relevance ranking algorithm 316 may include any suitable machine learning algorithm for relevance ranking. For example, relevance ranking algorithm 316 may apply machine learning tools and techniques known in the art such as clustering, decision tree, Bayes or a combination of machine learning techniques. Relevance ranking algorithm 316 trained with graded ranked data sources 314 provides a ranking model 318 for identifying the most relevant data sources associated with each of the topics with associated keywords 304. Ranking model 318 may be applied to new data sources added to first data set 212 to identify their most relevant topics. The top ranked data source (or top X data sources, where X is any positive integer) for each of the topics 304 may be associated with that respective topic.

In one embodiment, flow diagram 300 is performed multiple times with each successive relevance ranking algorithm 316 producing a new set of topics with associated keywords 304. Flow diagram 300 is also performed for different relevance ranking algorithms 316. The relevance ranking algorithm 316 that most accurately identifies the relevance of the data sources to the topic is selected to generate the model 318 for identifying a topic associated with data sources. In one embodiment, a relevance ranking algorithm 316 first operates on data sources 302 and the results are taken as a new data sources 302 for flow diagram 300 to act upon using a different relevance ranking algorithm 316 one or more times. The combination of two or more relevance ranking algorithms 316 is identified that produces the most accurate identification of data sources for a topic, and may be selected to generate model 318 for identifying a topic associated with additional data sources.

The weightings defined by user grading 312 may be different for each content set in first data set 212. As such, flow diagram 300 may be performed for each content set defined in first data set 212 to generate a different ranking model 318 for each content set.

FIG. 4 shows a flow diagram 400 for associating sections of additional data sources with one or more topics, in accordance with one or more embodiments. Flow diagram 400 of FIG. 4 will be discussed with reference to system architecture 200 of FIG. 2. Flow diagram 400 may be performed as a preprocessing step. For example, flow diagram 400 may be performed before receiving search query 206 as input 204. Flow diagram 400 may be performed by topic processor 214 in FIG. 2.

Additional data sources 402 are parsed 404 into sections 406. In one embodiment, additional data sources 402 are additional data sources of a particular content set stored in second data set 222. In one embodiment, additional data sources 402 are parsed into sections 406 based on headings defined in the additional data sources 402 or any appropriate linguistic or typographical factors. For example, sections 406 may be extracted from additional data sources 402 by identifying headings in additional data sources 402 and parsing the additional data sources 402 at points immediately prior to each heading. Sections 406 are input into search algorithm 410, along with topics with associated keywords 408. The topics with associated keywords 408 may be defined by a user (e.g., a user other than the end user of computing device 102).

Search algorithm 410 identifies sections that are most relevant to each of the topics. For example, in one embodiment, search algorithm 410 indexes sections 406 to determine keywords associated with sections 406, and compares the keywords from the topics with associated keywords 408 with the keywords associated with sections 406 to identify the sections that are most relevant to each of the topics. This process is repeated for each individual topic and corresponding keywords. In one embodiment, search algorithm 410 identifies the sections that are most relevant to each of the topics in turn according to methods known in the art. Search algorithm 410 provides ranked sections 412 of additional data sources, ranked from most relevant to least relevant to each topic.

Ranked sections 412 are presented 414 to a user, e.g., using a display device. User grading 416 is received from the user to evaluate the relevance of the ranked sections 412 to the topic, on a scale ranging from relevant to not relevant, to provide graded ranked sections 418. In one embodiment, the top J ranked sections 308 are graded with user grading 416, where J is any positive integer. The user grading 416 reflects weights that are applied on ranked sections 414. For example, the weights may be based on keywords appearing in additional data sources 402, the similarity of a section with another section that is already assigned a topic, or any other factor. These weights are inherent in user grading 416.

Graded ranked sections 418 are input into relevance ranking algorithm 420 as training data. Relevance ranking algorithm 420 may include any suitable machine learning algorithm for relevance ranking. For example, relevance ranking algorithm 420 may apply machine learning tools and techniques known in the art such as clustering, decision tree, Bayes or a combination of machine learning techniques. Relevance ranking algorithm 420 trained with graded ranked sections 418 provides a ranking model 422 for identifying the most relevant sections associated with each of the topics identified in topics with associated keywords 408. Ranking model 422 may be applied to new sections extracted from additional data sources added to second data set 222 to identify their most relevant topics. The top ranked section (or top Y sections, where Y is any positive integer) for each of the topics may be associated with that respective topic.

In one embodiment, flow diagram 400 is performed multiple times with each successive relevance ranking algorithm 420 producing a new set of topics with associated keywords 408. Flow diagram 400 is also performed for different relevance ranking algorithms 420. The relevance ranking algorithm 420 that most accurately identifies the relevance of the sections to the topic is selected to generate the model 422 for identifying a topic associated with sections of additional data sources. In one embodiment, relevance ranking algorithm 420 first operates on additional data sources 402 and the results are taken as a new additional data sources 402 for flow diagram 400 to act upon using a different relevance ranking algorithm 318 one or more times. The combination of two or more relevance ranking algorithms 420 is identified that produces the most accurate identification of sections for a topic, and may be selected to generate model 422 for identifying a topic associated with sections of additional data sources.

The weightings defined by user grading 416 may be different for each content set in second data set 222. As such, flow diagram 400 may be performed for each content set defined in second data set 222 to generate a different ranking model 422 for each content set.

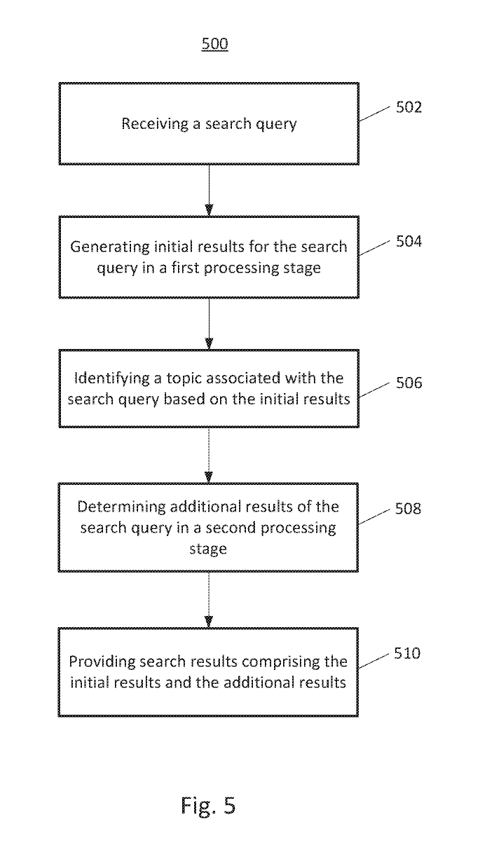

FIG. 5 shows a flow diagram of a method 500 of operation of the search query processing engine 202, in accordance with one or more embodiments. Method 500 will be discussed with reference to system architecture 200 of FIG. 2. Method 500 provides sections of documents, such as, e.g., regulatory filings, as additional results for a search query.

At step 502, a search query 206 is received. The search query 206 may be of any suitable format. For example, the search query 206 may be a string comprising one or more keywords.

At step 504, initial results 210 are generated for the search query 206 by search processor 208 in a first processing stage. The initial results 210 may be identified by comparing the search query 206 with keywords associated with data sources stored in a first data set 212. In one embodiment, the initial results 210 may be identified using methods known in the art.

At step 506, one or more topics 216 associated with the search query 206 are identified by topic processor 214 based on the initial results 210. For example, the topics 216 associated with the search query 206 may be identified as a topic associated with at least one of the initial results 210. In one embodiment, topics associated with the top N results (e.g., top 5 or 10 results) of the initial results 210 are identified as topics 216 associated with the search query 206.

At step 508, additional results 220 of the search query 206 are determined by comparator 218 in a second processing stage. The additional results 220 may be determined by comparing the topic 216 associated with the search query 206 with topics associated with sections of a document (e.g., additional data sources) stored in a second data set 222. In one embodiment, the additional results 220 may be determined to include a section of a document associated with a topic that matches (or most closely matches) the topic 216 associated with the search query 206. In one embodiment, the document is a regulatory filing. For example, the regulatory filing may be an EDGAR filing.

At step 510, search results 226 are provided comprising the initial results 210 and the additional results 220. The search results 226 may be presented to an end user via a display device.

Systems, apparatuses, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIGS. 3, 4, and 5. Certain steps of the methods described herein, including one or more of the steps of FIGS. 3, 4, and 5, may be performed by a server or by another processor in a network-based cloud-computing system. Certain steps of the methods described herein, including one or more of the steps of FIGS. 3, 4, and 5, may be performed by a client computer in a network-based cloud computing system. The steps of the methods described herein, including one or more of the steps of FIGS. 3, 4, and 5, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIGS. 3, 4, and 5, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

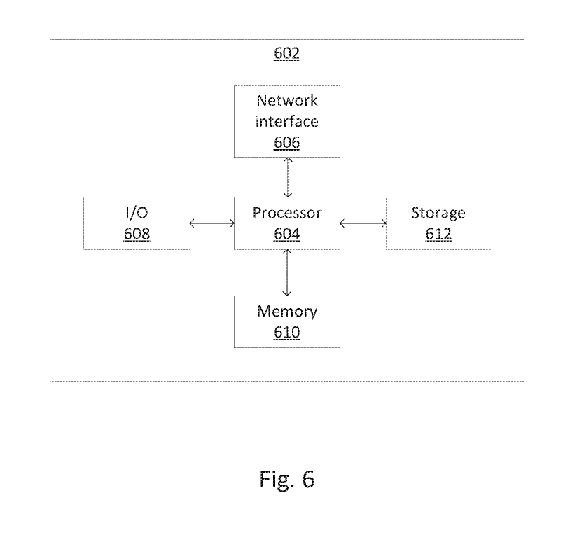

A high-level block diagram 600 of an example computer that may be used to implement systems, apparatus, and methods described herein is depicted in FIG. 6. Computer 602 includes a processor 604 operatively coupled to a data storage device 612 and a memory 610. Processor 604 controls the overall operation of computer 602 by executing computer program instructions that define such operations. The computer program instructions may be stored in data storage device 612, or other computer readable medium, and loaded into memory 610 when execution of the computer program instructions is desired. Thus, the steps of FIGS. 3, 4, and 5 can be defined by the computer program instructions stored in memory 610 and/or data storage device 612 and controlled by processor 604 executing the computer program instructions. For example, the computer program instructions can be implemented as computer executable code programmed by one skilled in the art to perform the steps of FIGS. 3, 4, and 5. Accordingly, by executing the computer program instructions, the processor 604 executes the steps of FIGS. 3, 4, and 5. Computer 602 may also include one or more network interfaces 606 for communicating with other devices via a network. Computer 602 may also include one or more input/output devices 608 that enable user interaction with computer 602 (e.g., display, keyboard, mouse, speakers, buttons, etc.).

Processor 604 may include both general and special purpose microprocessors, and may be the sole processor or one of multiple processors of computer 602. Processor 604 may include one or more central processing units (CPUs), for example. Processor 604, data storage device 612, and/or memory 610 may include, be supplemented by, or incorporated in, one or more application-specific integrated circuits (ASICs) and/or one or more field programmable gate arrays (FPGAs).

Data storage device 612 and memory 610 each include a tangible non-transitory computer readable storage medium. Data storage device 612, and memory 610, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 608 may include peripherals, such as a printer, scanner, display screen, etc. For example, input/output devices 608 may include a display device such as a cathode ray tube (CRT) or liquid crystal display (LCD) monitor for displaying information to the user, a keyboard, and a pointing device such as a mouse or a trackball by which the user can provide input to computer 602.

Any or all of the systems and apparatus discussed herein, including computing devices 102 and search query processing engine 106 of FIG. 1 and search query processing engine 202 of FIG. 2, may be implemented using one or more computers such as computer 602.

One skilled in the art will recognize that an implementation of an actual computer or computer system may have other structures and may contain other components as well, and that FIG. 6 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for processing a search query, comprising:
receiving a search query;
generating initial results for the search query in a first processing stage;
identifying a topic associated with the search query based on the initial results;
determining additional results for the search query in a second processing stage, the additional results being associated with a topic that matches the topic associated with the search query; and
providing search results comprising the initial results and the additional results.

2. The method as recited in claim 1, wherein identifying a topic associated with the search query based on the initial results comprises:
identifying the topic associated with the search query as a topic associated with at least one of the initial results.

3. The method as recited in claim 2, wherein identifying the topic associated with the search query as a topic associated with at least one of the initial results comprises:
identifying the topic associated with the search query as a topic associated with a top N results of the initial results.

4. The method as recited in claim 2, further comprising:
associating the topic associated with at least one of the initial results with the at least one of the initial results using a trained relevance ranking algorithm.

5. The method as recited in claim 1, further comprising:
associating the topic associated with the additional results with the additional results using a trained relevance ranking algorithm.

6. The method as recited in claim 1, wherein the additional results include a section extracted from a document.

7. The method as recited in claim 1, wherein the additional results include a regulatory filing.

8. The method as recited in claim 7, wherein the regulatory filing is an EDGAR (electronic data gathering, analysis, and retrieval) filing.

9. The method as recited in claim 1, wherein providing search results comprises:
displaying the search results on a display device.

10. A computer readable medium storing computer program instructions for processing a search query, which, when executed on a processor, cause the processor to perform operations comprising:
generating initial results for a search query in a first processing stage;
identifying a topic associated with the search query based on the initial results;
determining additional results for the search query in a second processing stage, the additional results being associated with a topic that matches the topic associated with the search query; and
providing search results comprising the initial results and the additional results.

11. The computer readable medium as recited in claim 10, wherein identifying a topic associated with the search query based on the initial results comprises:
identifying the topic associated with the search query as a topic associated with at least one of the initial results.

12. The computer readable medium as recited in claim 11, wherein identifying the topic associated with the search query as a topic associated with at least one of the initial results comprises:
identifying the topic associated with the search query as a topic associated with a top N results of the initial results.

13. The computer readable medium as recited in claim 11, the operations further comprising:
associating the topic associated with at least one of the initial results with the at least one of the initial results using a trained relevance ranking algorithm.

14. The computer readable medium as recited in claim 10, the operations further comprising:
associating the topic associated with the additional results with the additional results using a trained relevance ranking algorithm.

15. The computer readable medium as recited in claim 10, wherein the additional results include a section extracted from a document.

16. A system for processing a search query, comprising:
a first content database;
a second content database; and
a search query processing engine configured to:
receive a search query;
generate initial results for the search query in a first processing stage;
identify a topic associated with the search query based on the initial results;
determine additional results for the search query in a second processing stage, the additional results being associated with a topic that matches the topic associated with the search query; and
provide search results comprising the initial results and the additional results.

17. The system as recited in claim 16, wherein the search query processing engine comprises:
a search processor configured to:
receive the search query, and
generate the initial results for the search query in the first processing stage;
a topic processor configured to identify the topic associated with the search query; and
a comparator configured to:
determine the additional results from the second content database for the search query in the second processing stage, and
provide the search results comprising the initial results and the additional results.

18. The system as recited in claim 16, wherein the additional results include a regulatory filing.

19. The system as recited in claim 18, wherein the regulatory filing is an EDGAR (electronic data gathering, analysis, and retrieval) filing.

20. The system as recited in claim 16, further comprising a display device to display the search results.
